(19) United States
(12) Patent Application Publication
(10) Pub. No.: US 2024/0076128 A1
(43) Pub. Date: Mar. 7, 2024

(54) Winch Assembly of a Load Handling Device

(71) Applicant: Ocado Innovation Limited, Hatfield, Hertfordshire (GB)

(72) Inventor: Kelvin EVANS, Hatfield, Hertfordshire (GB)

(21) Appl. No.: 18/261,561

(22) PCT Filed: Jan. 14, 2022
(86) PCT No.: PCT/EP2022/050815

§ 371 Date: Jul. 14, 2023

(30) Foreign Application Priority Data
Jan. 15, 2021 (GB) 2100557.4

(51) Int. Cl. B65G 1/04; B66C 1/10; B66C 19/00; B66D 1/38; B66D 1/39

(52) U.S. Cl. CPC B65G 1/0464; B66C 1/101; B66C 19/00; B66D 1/38; B66D 1/39

(57) ABSTRACT

A load handling device is provided for lifting and moving containers stacked in a storage system including a grid framework. The load handling device includes a vehicle body housing a wheel drive mechanism and a wheel assembly. A container lifting assembly comprising a container gripping assembly, a plurality of winch assemblies each includes a rotatable drum and a lifting tether anchored at a first end to the gripping assembly and at a second end to the drum, and a drive assembly configured to drive rotation of the drums to raise the gripping assembly into a container receiving space. Each drum has an outer surface configured to accommodate a plurality of axially displaced turns of the lifting tether across the drum.

### TECHNICAL FIELD

The present invention relates to the field of load handling devices for handling storage containers or bins in an automated storage system comprising stacked containers arranged in a grid framework structure, more particularly to a winch assembly of the load handling device.

### INTRODUCTION

Storage systems comprising a three-dimensional storage grid structure, within which storage containers/bins are stacked on top of each other, are well known. PCT Publication No. WO2015/185628A (Ocado) describes a known storage and fulfilment system in which stacks of bins or containers are arranged within a grid framework structure. The bins or containers are accessed by robotically controlled load handling devices operative on tracks located on the top of the grid framework structure. A system of this type is illustrated schematically in FIGS. 1 to 3 of the accompanying drawings.

As shown in FIGS. 1 and 2, stackable containers, known as bins 10, are stacked on top of one another to form stacks 12. The stacks 12 are arranged in a grid framework structure 14 in a ware-housing or manufacturing environment. The grid framework structure is made up of a plurality of storage columns or grid columns. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The grid framework structure 14 comprises a plurality of upright members 16 that support horizontal members 18, 20. A first set of parallel horizontal members 18 is arranged perpendicularly to a second set of parallel horizontal members 20 to form a plurality of horizontal grid structures supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10, and guides vertical movement of the bins 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

A known load handling device 30 shown in FIG. 4 comprises a vehicle body 32 and is described in PCT Patent Publication No. WO2015/019055 (Ocado), hereby incorporated by reference. Here, the load handling device 30 comprises a wheel assembly comprising a first set of wheels 34 consisting a pair of wheels on the front of the vehicle 32 and a pair of wheels 34 on the back of the vehicle 32 for engaging with the first set of rails or tracks to guide movement of the device in a first direction and a second set of wheels 36 consisting of a pair of wheels 36 on each side of the vehicle 32 for engaging with the second set of rails or tracks to guide movement of the device in a second direction. The vehicle body of the load handling device comprises an upper portion and a lower portion. The wheels are arranged around the periphery of a cavity or recess, known as a container-receiving recess 40, in the lower portion of the vehicle body. The load handling device 30 as shown in FIG. 5 comprises a lifting mechanism comprising a winch or a crane mechanism to lift a storage container or bin, also known as a tote, from above and a container gripping assembly or grabber device 39. The lifting mechanism is located in the upper portion of the vehicle body. The winch crane mechanism comprises a lifting tether 38 wound on a spool or reel (not shown). The container gripping assembly 39 is configured to grip the top of the container 10 to lift it from a stack of containers in a storage system of the type taught in PCT Patent Publication No. WO2015/019055 (Ocado). The winch mechanism is driven by a drive mechanism (not shown), commonly as Z-motors for reason that the Z-motors is configured to raise and lower the container gripping assembly in the Z direction when lifting and lowering a storage container. During operation of the drive mechanism when lowering the container gripping assembly, the lifting tether is paid out from the spool.

It is essential during a picking operation, that the container gripping assembly remains horizontal at all times, particularly when engaging with a storage container otherwise there is the potential risk that at least one of the lifting tethers holding the container gripping assembly may tear if subjected to unbalanced and high loads. To possess the necessary physical properties (Young's Modulus) to bear the load of the storage container which can be as heavy as 35 kg, the lifting tethers are generally in the form of a tape or band, usually made of metal (commonly a steel alloy). Typically, the container gripping assembly is configured as a frame and four lifting tapes are fixed to each or proximate to the corner of the container gripping assembly, each of the four lifting tape are wound on separate spools. To ensure that the container gripping assembly remains horizontal, is it is important that the length of all of the tapes is kept the same at all times during operation of the container gripping assembly. To ensure that the length of all of the tethers anchored to the grabber device are the equal such that the container gripping assembly is kept horizontal during operation, the length of each of the tapes must be adjusted both initially, as well as at various service intervals since they tend to elongate or stretch over time which can be attributed to numerous factors such as environmental, motor wear, stretching of the tape and so on. In an extreme case where the length of any one of the tapes is not equal, the container gripping assembly may fail to engage with the container either because its descent falls too short or overshoots the container. Traditionally, the tapes are connected and spooled onto separate reels arranged within an upper level of the housing or body of the load handling device. The travel length of a lifting band per rotation of the spool onto which the lifting band is reeled is dependent on the number of layers of the lifting band wound onto the spool.

To adjust a tape and to remove any slack in the reel, the corresponding spool or reel may be disconnected from a rotational shaft and the tape adjusted by free rotation of the reel or spool relative the rotational shaft. The reel or spool is subsequently mounted to the rotational shaft when the band has the desired length. A variant to this method is to provide adjustable lifting band connectors fixed to the container gripping assembly as taught in WO 2019/206438 (Autostore Technology). Each adjustable lifting connector comprises a bracket and a band connector hub, the bracket is connected to the container gripping assembly and the band connector hub is connected to the bracket and one of the lifting bands, such that movement of the band connector hub relative to the bracket will adjust the vertical distance between a respective corner section of the container gripping assembly and the lifting band drive assembly.

The use of lifting tapes to suspend the container gripping assembly from the spools provides an advantage that the length of the tape extending between the container gripping assembly and the spools can be precisely controlled. This is because the lifting tape has a predetermined uniform thickness such that the number of turns of the tape as it is wound around the spool can be easily calculated. The tape is generally relatively thin (usually about 0.1 to 0.3 mm thickness) to enable multiple overlaps of the tape to be wound on a spool. This greatly increases the length of tape that can be spooled or drawn out from the spool and thereby, allows the container gripping assembly suspended from the lifting tape to reach storage containers stored at greater depths within the storage system which can be as high as 21 storage containers. However, the problem with the use of tape to suspend the container gripping assembly from the spool is that the tape is susceptible to being damaged. This is particularly exacerbated where the thickness of the tape is relatively thin to enable multiple overlaps of the lifting tape to be wound on the spool. Any kinking of lifting tapes affects the length of an individual tape and thus, the separation between the spool and the container gripping assembly. Kinking is a permanent crease or bend or twist that has developed in the tape and is particularly pronounced as the lifting tape is composed of metal. As a result, a portion of the length of the tape is taken up by the kink. Since the container gripping assembly is suspended by more than one lifting tape, any variation in length in anyone of the tapes due to kinking affects the orientation of the container gripping assembly relative to a horizontal plane and thereby, potentially affects its ability to engage with a storage container below. Replacing the tape with another type of tether such as rope or a cable suffers from the problem that the length of the tether cannot be controlled precisely, particularly as the tether is required to overlap or wrap around each other on the spool and thereby, greatly affecting the orientation of the container gripping assembly during operation, i.e. not kept substantially horizontal during operation.

It is, therefore, a primary object of the present invention to provide a lifting mechanism that does not suffer from the above problems.

### SUMMARY OF THE INVENTION

The present applicant has mitigated the above problem by providing a plurality of winch assemblies for a load handling device operative to lift and move one or more containers stacked in a storage system comprising a grid framework structure supporting a plurality of tracks arranged in a grid pattern to define a grid structure comprising a plurality of grid cells above the one or more stacks of containers, each winch assembly of the plurality of winch assemblies comprising an elongated drum rotatable about its central axis of rotation, the elongated drum having an outer surface that is configured to accommodate a plurality of axially displaced turns of the lifting tether such that rotation of the drum causes the lifting tether to coil around the outer surface of the drum.

More specifically, the present invention provides a load handling device for lifting and moving containers stacked in a storage system comprising a grid framework comprising a plurality of grid members arranged in a grid pattern above the stacks of containers, the load handling device comprising:
i) a vehicle body housing a wheel drive mechanism operatively arranged for moving the load handling device on the grid framework and a wheel assembly comprising a first set of wheels for engaging with a first set of grid members to guide movement of the load handling device in a first direction and a second set of wheels for engaging with a second set of grid members to guide the movement of the load handling device in a second direction, wherein the second direction is transverse to the first direction;
ii) a container lifting assembly comprising:
   a) a container gripping assembly configured, in use, to releasably grip a storage container;
   b) a plurality of winch assemblies, each winch assembly of the plurality of winch assemblies comprising a drum rotatable about its central axis of rotation, and a lifting tether having a first end anchored to the container gripping assembly and a second end anchored to the drum, and
   c) a drive assembly configured to drive rotation of the drums of the plurality of winch assemblies about their respective central axis of rotation to raise the container gripping assembly into a container receiving space;
characterised in that;
each of the respective drums of the plurality of winches has an outer surface that is configured to accommodate a plurality of axially displaced turns of the lifting tether across the drum such that rotation of the drum causes the lifting tether to form helical turns of the lifting tether around the outer surface of the drum.

In contrast to winding the lifting tether in the form of a tape or band around a wheel or spool to form multiple layers of overlapping lifting bands, the present invention provides a drum that is elongated with an outer surface that is configured to accommodate a plurality of axially displaced turns of the lifting tether across the longitudinal length of the drum so as to cause the lifting tether to be coiled around the outer surface of the drum. Thus, instead of controlling the travelling length of the lifting tape by the number of layers of the lifting band wound on the spool, the helical turns of the lifting tether wound evenly around the rotating drum allows the travelling length of the lifting tether to be precisely controlled. Thus, each helical turn of the lifting tether coiled around the drum accounts for a predetermined amount of travelling length of the lifting tether. Multiple helical turns or coils of the lifting tether around the drum represents a controlled length of lifting tether that can be paid out from the rotating drum. The drum has a uniform cross-sectional diameter such that a predetermined amount of the lifting tether is paid out per revolution of the drum. The use of an elongated drum to carry the lifting tether also increases the ability to use different types of lifting tethers connecting the drive assembly to the container gripping assembly and is not limited to use of a lifting tape or band as found in prior art container gripping lifting mechanisms. For example, the lifting tether can be a rope or cable or string that is sufficiently flexible and does not suffer from kinking as present in metallic type tapes or bands. Optionally, the lifting tether can comprise Dyneema® an ultra-high molecular weight polyethylene (UHMwPE) material that is sufficiently strong to be made sufficiently thin so that multiple helical turns can be made around the drum and yet bear the load of the storage container.

Preferably, each of the plurality of winch assemblies comprises a guide member configured to translate axially along a direction parallel to the central axis of rotation of its respective drum so as to guide the winding and/or unwinding of the lifting tether around the outer surface of the drum. The guide member ensures that the helical turns of the lifting tether are distributed uniformly across the longitudinal length of the drum and optionally, without overlapping such that the drum accommodates only a single layer of the lifting tether when the container gripping assembly is raised into the container receiving space. The single layer of the lifting tether prevents damage to the lifting tether. For example, if the rope wraps around itself a number of times to form multiple layers before the drum is driven in an opposite direction, this will cause the lifting tether to jump down onto the last completed wrap when the container gripping assembly is lowered, thereby stressing or shocking the lifting tether. When the load from the storage container is high (e.g. typically 35 kg) the shock to the lifting tether is correspondingly high and can, under certain conditions, shorten the life of the lifting tether or cause damage to the lifting mechanism. This will cause an imbalance in the length of the lifting tether used to suspend the container gripping assembly.

In the present invention, there are two ways that the guide member can translate across the drum to wind and unwind the lifting tether when lifting or lowering the container gripping assembly. Optionally, the guide member is moveable relative to the drum in the direction parallel to the central axis of rotation of the drum. For example, the outer surface of the drum is provided with a helical seat comprising a helical groove for receiving helical turns of the tether and the guide member is configured to threadingly engage with the helical seat of the drum, so that rotation of the drum directly controls the movement of the guide member across the drum in a direction parallel to the rotational axis of the drum. Optionally, the drum is configured to move relative to the guide member in the direction parallel to its central axis of rotation such that rotation of the drum causes the drum to translate along a direction parallel to the central axis of rotation of the drum to guide the winding and/or unwinding of the tether around on the outer surface the drum.

Preferably, the second end of the lifting tether is anchored to the drum of a respective winch assembly by being received within a recess formed in the drum. Preferably, the recess is a hole formed towards one end of the drum. Optionally, a fixing mechanism is used to anchor the second end of the lifting tether to the drum.

Preferably, the drive assembly comprises at least one lifting or drive shaft coupled to the respective drums of the plurality of winch assemblies and at least one motor for rotating the at least one lifting or drive shaft. For avoidance of doubt, the term “drive shaft” and “lifting shaft” are used interchangeably in the patent specification to mean the same feature. Preferably, the lifting shaft is coupled to the at least one motor by at least one timing belt and/or pulley system and/or gear mechanism such that rotary motion of the least one motor is transferred to the least one lifting shaft to raise and lower the container gripping assembly. Optionally, the drums of the plurality of winch assemblies are driven by at least two rotating lifting or drive shafts arranged in the vehicle body of the load handling device, wherein the lifting or drive shafts are further coupled via belts/chains and/or gear mechanism to at least one motor for providing synchronized rotational movement to the at least two lifting or drive shaft. Optionally, the plurality of winch assemblies comprises a first and second set of drums and the at least one drive shaft comprises a first and second drive shafts, the first set of drums being mounted on the first drive shaft and the second set of drums being mounted on a second drive shaft. Optionally, the at least one motor is a single motor configured to drive the rotation of the first and second drive shafts. Optionally, the pulley system comprises a first drive pulley mounted to the first drive shaft and a second drive pulley mounted to the second drive shaft and wherein the single motor is connected to the first and second drive shafts by a single belt around the respective first and second drive pulleys such that the single motor drives rotation of the first and second sets of drums. Preferably, the at least one drive shaft further comprises a motor drive shaft mounted to the single motor and a motor drive pulley mounted to the motor drive shaft such that the single motor is connected to the first and second drives shafts by the single belt around the respective motor drive pulley and the first and second drive pulleys such that rotation of the motor drive shaft drives rotation of the first and second sets of drums in synchronization. This arrangement allows the lifting tether to be paid out from each drum at the same speed without the need for additional motors, thereby ensuring that the container gripping assembly remains horizontal as it is lowered. Similarly, the arrangement allows the lifting tether to be wound around each drum at the same speed, thereby ensuring that the container gripping assembly remains horizontal as it is raised.

Alternatively, the at least one motor comprises a plurality of motors such that the number of winch assemblies is equal to the number of motors. Preferably, the plurality of motors are driven in synchronisation such that the drums of the plurality of winches are driven to rotate about their respective central axis of rotation in synchronisation. Thus, instead of at least one motor coupled to the at least two lifting shafts via at least one timing belt and/or pulley system and/or gear mechanism, the least two lifting shafts are rotationally driven by separate motors that provides synchronized rotational movement of the at least two lifting shafts, and thus, the drums mounted to the at least two lifting shafts.

Preferably, the plurality of winch assemblies comprises four winches such that the container gripping assembly is anchored to four lifting tethers. Preferably, the container gripping assembly comprises a frame having four corners and each of the four lifting tethers is anchored to one of the respective corners of the container gripping assembly. The four lifting tethers connected to the four corners of the container gripping assembly ensure that the container gripping assembly is kept horizontal during operation when lifting and lowering a storage container into and out of a grid cell.

The speed by which the container gripping assembly device travels vertically is also dependent on the cross-sectional diameter of the drum. Thus, for a given rotational speed of the drum, a larger cross-sectional diameter of the drum results in the container gripping assembly travelling faster when being raised or lowered. Conversely, a smaller cross-sectional diameter results in the container gripping assembly travelling slower when being raised or lowered. In an aspect of the present invention, at least a portion of the drum of at least one winch assembly has a cross-sectional diameter that is variable. Preferably, at least a portion of the drum of the at least one winch assembly is tapered. By having at least a portion of the drum tapered, the speed by which the container gripping assembly is raised or lowered can be varied. This is particularly important when the container gripping assembly is descending into engagement with a storage container. As the container gripping assembly approaches the storage container, its speed is slowed so as to prevent the container gripping assembly crashing into the storage container.

Optionally, the first and second set of wheels of the wheel assembly comprises a wheel positioning mechanism configured to selectively lower or raise the first set of wheels or the second set of wheels relative to the vehicle body and thereby, to selectively engage or disengage the first set of wheels with the first set of grid members or the second set of wheel with the second set of grid members.

The wheel positioning mechanism can comprise one more linkages driven by a linear actuator or motor to selectively lower or raise the first set of wheels or the second set of wheels into engagement or disengagement with the first set of tracks or rails or the second set of tracks or rails.

The present invention further provides a storage and retrieval system comprising:
a first set of tracks and a second set of tracks running transversely to the first set in a substantially horizontal plane to form a grid pattern comprising a plurality of grid spaces or grid cells;
a plurality of stack of containers located beneath the first set of parallel pathways and second set of parallel pathways, wherein each of the stack of containers occupies a single grid space or grid cell,
a load handling device according to the present invention arranged to traverse along the first set and the second set of tracks over the plurality of grid spaces or grid cells such that when positioned above a stack of containers occupying a grid space or grid cell, the container lifting assembly is configured to lift at least one container from said stack of containers.

### DETAIL DESCRIPTION OF THE DRAWINGS

Further features and aspects of the present invention will be apparent from the following detailed description of an illustrative embodiment made with reference to the drawings, in which:

FIG. 1 is a schematic diagram of a grid framework structure according to a known system,

FIG. 2 is a schematic diagram of a top down view showing a stack of bins arranged within the framework structure of FIG. 1.

FIG. 3 is a schematic diagram of a known storage system showing a load handling device operative on the grid framework structure.

FIG. 4 is a schematic perspective view of the load handling device showing the lifting device gripping a container from above.

FIGS. 5(a) and 5(b) are schematic perspective cut away views of the load handling device of FIG. 4 showing (a) a container accommodating a container receiving space of the load handling device and (b) the container receiving space of the load handling device.

FIG. 6 is a perspective side view of a load handling device showing a known lifting mechanism.

FIG. 7 is a perspective frontal view of the container gripping assembly or grabber device according to the embodiment of the present invention.

FIG. 8 is a perspective underside view of the container gripping assembly according to the embodiment of the present invention.

FIG. 9 is a perspective side view of the load handling device incorporating the plurality of winch assemblies according to the embodiment of the present invention.

FIG. 10 is a different perspective view of the load handling incorporating the plurality of winch assemblies according to the embodiment of the present invention.

FIG. 11 is an underside perspective view of the load handling device incorporating the plurality of winch assemblies according to the embodiment of the present invention.

FIG. 12 is a frontal perspective view of the load handling device carrying a storage container according to an embodiment of the present invention.

FIG. 13 is an expanded perspective view of a winch assembly according to an embodiment of the present invention.

FIG. 14 is an expanded perspective view of a winch assembly at a different angle according to an embodiment of the present invention.

FIG. 15 is a perspective view of a lifting drum of the winch assembly shown in FIGS. 9 to 14 according to an embodiment of the present invention.

FIG. 16 is a perspective view of a lifting drum of the winch assembly according to another embodiment of the present invention.

### DETAILED DESCRIPTION

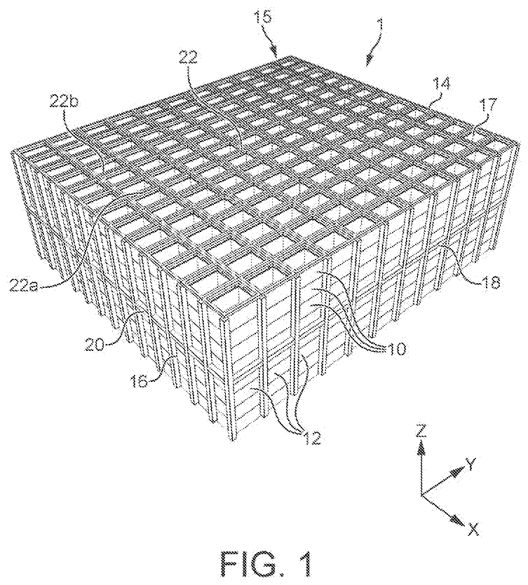

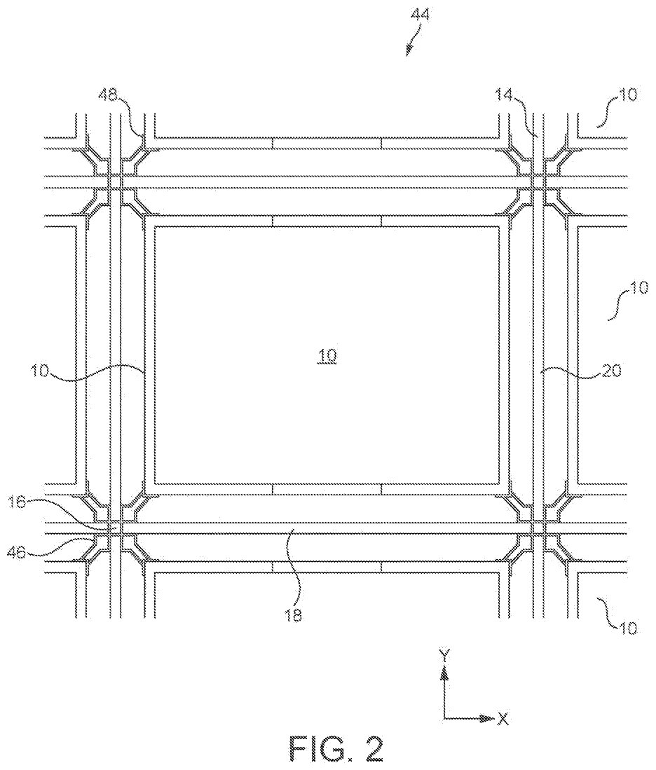

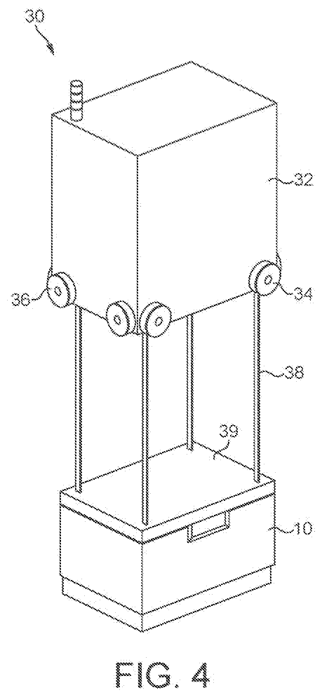

It is against the known features of the storage system such as the grid framework structure and the load handling device described above with reference to FIGS. 1 to 5, the present invention has been devised.

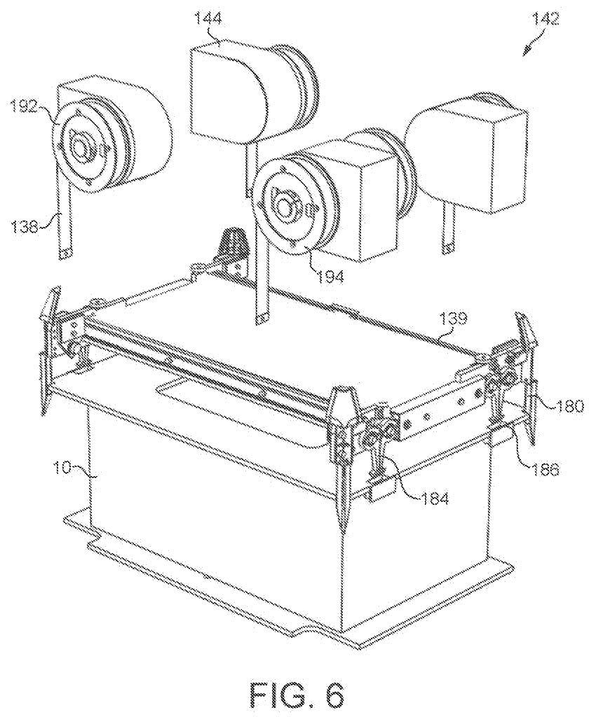

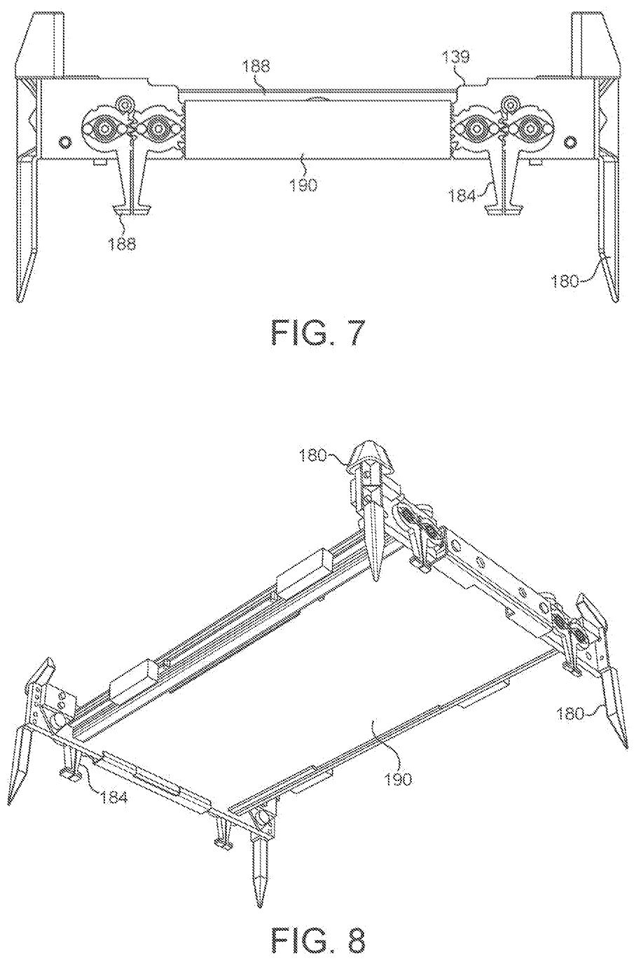

FIG. 6 shows a lifting mechanism or container lifting assembly 142 comprising a container gripping assembly 139, otherwise known as a grabber device, for releasably connecting to a storage container 10 below and a drive assembly 144 to raise and lower the grabber device 139. For the avoidance of doubt, the term “lifting mechanism” and “container lifting assembly” are used interchangeably in the patent specification to mean the same feature. To raise and lower the grabber device 139, the lifting mechanism or container lifting assembly of prior art load handling devices comprises a set of lifting tapes or bands 138 extending in a vertical direction between the grabber device 139 and the drive assembly 144. For maximum stability and load capacity, commonly four separate lifting tapes 138 are shown extending between the drive assembly 144 and at each corner of the grabber device 139. In an exemplary embodiment of the present invention, the grabber device 139 is formed as a frame having four corner sections, a top side 188 and a bottom side 190 (see FIG. 7). To grab a container 10, the grabber device 139 comprises four locating pins or guide pins 180 nearby or at each corner of the grabber device 139 which mate with corresponding cut outs or holes (not shown) formed at four corners of the container 10. Four gripper elements 184 arranged at the bottom side of the grabber device 139 to engage with the rim of the container (see FIGS. 7 and 8). The locating pins 180 help to properly align the gripper elements 184 with corresponding holes in the rim of the container 10.

In the particular embodiment shown in FIG. 7, each of the gripper elements 184 comprises a pair of wings that are collapsible so as to be receivable in corresponding holes 186 in the rim of the container (see FIG. 6) and an open or enlarged configuration having a size greater than the holes 186 in the rim of the container in at least one dimension so as to lock onto the container (see FIG. 6). The wings are actuated into the open and closed configuration by a suitable actuating mechanism coupled to a drive gear. More specifically, the head of at least one of the wings comprises a plurality of teeth that mesh with the drive gear such that when the gripper elements 184 are actuated by the actuating mechanism, rotation of the drive gear causes the pair of wings to rotate from a closed or collapsed configuration to an open enlarged configuration (FIGS. 7 and 8). When in the collapsed or closed configuration, the gripper elements 184 are sized to be receivable in corresponding holes 186 in the rim of the container as shown in FIG. 6. The foot of each of the pair of wings comprises a stop 188, e.g. a boss, such that when received in a corresponding hole 186 in the rim of the container, the stop 188 engages with an underside of the rim when in an enlarged open configuration to lock onto the container when the grabber device 139 is winched upwards towards the container-receiving portion of the load handling device.

Also shown in FIG. 6 is that each of the four lifting tapes 138 are wound onto separate spools or reels 192 that are driven for rotational movement by a drive mechanism or drive assembly 144 comprising separate drive motors to raise and lower the grabber device 139. The lifting tape 138 are wound on their respective spool 192 in multiple layers. To ensure that the lifting tape 138 overlays or wraps upon itself when being wound on the spool 192, opposing ends of the spool 192 comprise flanges 194 to constrain the lifting tape 138 onto the spool 192. The width of the spool between the flanges is approximately the width of the lifting tape.

The drive motors 144 are typically brushless DC electric motors. The separate drive motors 144 are driven in synchronisation to provide synchronised rotational movement of all of the spools 192. This helps to keep the grabber device 139 horizontal during operation so as to allow the grabber device, in particular the gripper elements 184 to properly engage with the storage container 10. Other methods to drive rotation of the spools are known in the art. For example, the lifting tapes 138 can be spooled on and off their respective spools or reels 192 by being connected to at least two rotating lifting shafts (not shown) arranged within the body of the load handling device. The at least two lifting shafts are coupled to a suitable motor via at least one drive belt or gears to drive the rotation of the lifting shafts. In order to ensure that the grabber device is kept horizontal during operation, the length of the lifting tapes 138 between each of the drive motors 144 and the grabber device 139 should be equal. Traditionally, to ensure that the length of all the lifting tapes relative to the grabber device are substantially equal, the length of each of the lifting tapes mounted on separate reels or spools 192 must be adjusted at various service levels since they tend to elongate during use. One way in the art of adjusting the length of the lifting tape is to disconnect the spool or reel 192 from its corresponding drive shaft and subsequently remove any slack in the tape.

The lifting tape 138 is generally thin (typically less than 0.5 mm thick) and typically, made of metal. The thinness of the lifting tape allows the lifting tape to be wrapped around itself in multiple layers and provides better control of the travelling length of the lifting tape when it is paid out from its corresponding spool. However, the drawback to using a lifting tape 138 to suspend the grabber device 139 is that it can easily ‘kink’ or twist or crease resulting in a small portion of the lifting tape being taken up by the kink with the resultant effect that the separation between the drive motor and the grabber device anchored to the ‘kinked’ lifting tape changes. Since each of the lifting tapes 138 are anchored to the corners of the grabber device 139, if at least one of the lifting tapes kinks, this causes the orientation of the grabber device to change, especially if the lifting tape is subsequently wound on its respective spool, losing its ability to be keep the grabber device in a horizontal orientation. To remedy this problem, the spool 192 carrying the damaged lifting tape is removed and replaced with a fresh spool of lifting tape. This not only increases the cost of the lifting assembly but the lifting tapes have to be re-calibrated each time a spool is replaced increasing downtime of the load handling device operational on the grid framework structure.

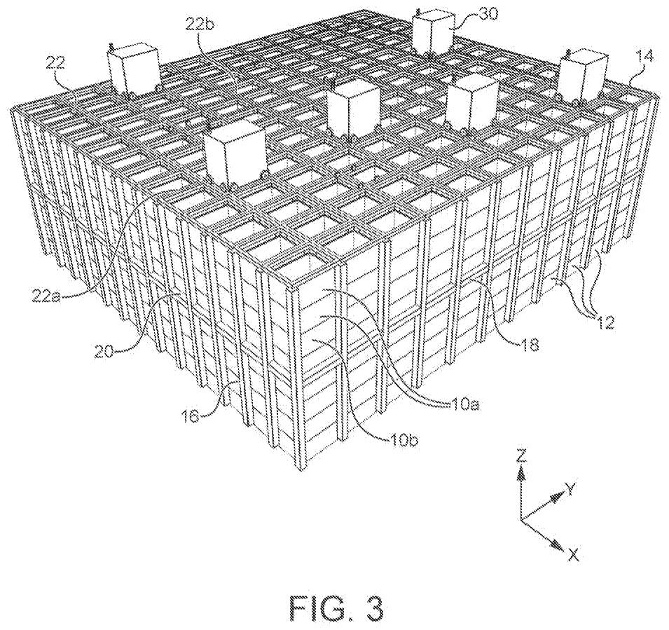

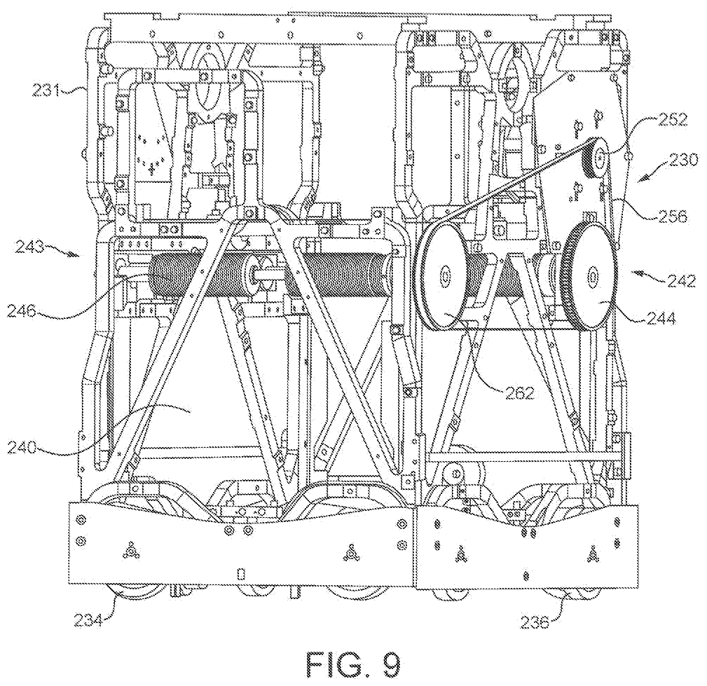

FIG. 9 shows a load handling device 230 according to an embodiment of the present invention operable in a storage system 1 described with reference to FIGS. 1 and 3. The load handling device 230 comprises a frame or chassis or skeleton 231 to which body panels (not shown) are fixed to the exterior of the chassis 231 to form a vehicle body. The vehicle body comprises an upper part and a lower part (see FIG. 9). The lower part is fitted with two sets of wheels 234, 236, which run on rails at the top of the framework structure of the storage system (not shown). Each set of wheels 234, 236 is driven to enable movement of the vehicle in X and Y directions respectively along the rails. One or both sets of wheels can be moved vertically by a wheel positioning mechanism comprising one or more wheel lifting motors to lift each set of wheels clear of the respective rails, thereby allowing the vehicle to move in the desired direction.

In accordance with an embodiment of the present invention, it is preferable that all of the first 234 and second 236 set of wheels are engaged with their respective grid members or tracks prior to the other first or second set of wheels being raised, i.e. stowed. To do this, the wheels that are in a stowed or raised position are lowered first to engage with the grid members or tracks before the other set of wheels are raised or stowed. Lowering a set of wheels that are currently engaged with the grid members or tracks when the other set of wheels are in the raised position so that all of the first and second sets of wheels are engaged with the grid members or tracks would put a huge burden on the one or more wheel lifting motors as the wheel lifting motors would have to bear the full weight of the load handling device which can reach weights of about 160 kg. Equally, lifting the vehicle to disengage a set of wheels from the grid members or tracks would burden the wheel lifting motors to lift the weight of the vehicle. In the particular embodiment of the present invention, the first or second sets of wheels are raised or lowered once all of the wheels of the first and second sets of wheels are engaged with the grid members or tracks. Thus, the wheel positioning mechanism involves a two stage process. The first is the process of engaging all of the first and second sets of wheels with the grid members or tracks and the second process involves lifting the relevant first or second sets of wheels depending on whether the load handling device is travelling in the X direction or the Y direction on the grid structure.

For example, once all of the first and second set of wheels are engaged with the grid members or tracks (i.e. in the deployed position) so that the load handling device is supported by all eight wheels, the relevant sets of wheels (first or second sets of wheels) are raised or stowed depending on whether the load handling device is moving in the X direction or the Y direction. This removes the need for the wheel lifting motors to lift the vehicle when needing to disengage the first or second sets of wheels from the grid members or tracks. The first or second set of wheels are raised in the stowed position in synchronization so that all of the first or second sets of wheels are raised at substantially the same time.

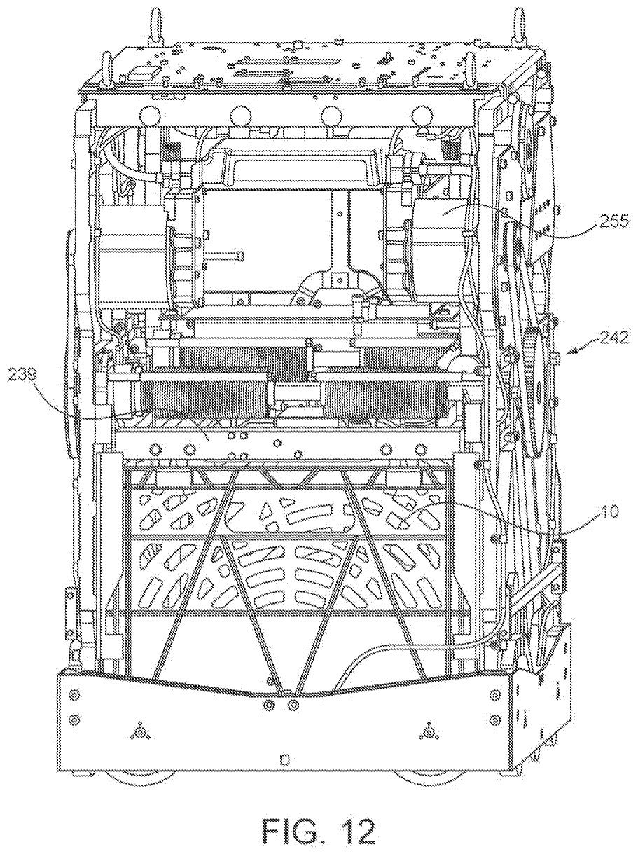

The wheels 234, 236 are arranged around the periphery of a cavity or recess, known as a container receiving space 240, in the lower part. The space 240 is sized to accommodate the container 10 when it is lifted by the lifting assembly 242, as shown in FIGS. 9 and 12. When in the container receiving space, the container is lifted clear of the rails beneath, so that the load handling device 230 can move laterally to a different location. On reaching the target location, for example another stack, an access point in the storage system or a conveyor belt, the bin or container can be lowered from the container receiving space and released from the grabber device 239 (see FIG. 12). Whilst the container receiving space 240 for accommodating a container is arranged within the vehicle body shown in FIG. 9, the present invention is not limited to the container receiving space 240 being located within the vehicle body. The present invention is also applicable to the container receiving space being located below a cantilever such as in the case where the vehicle body of the load handling device has a cantilever construction as described in WO2019/238702 (Autostore Technology AS). For the purpose of the invention, the term ‘vehicle body” is construed to optionally cover a cantilever such that the grabber device is located below the cantilever. However, for ease of explanation of the present invention, the container receiving space for receiving a container is arranged within a cavity or recess within the vehicle body.

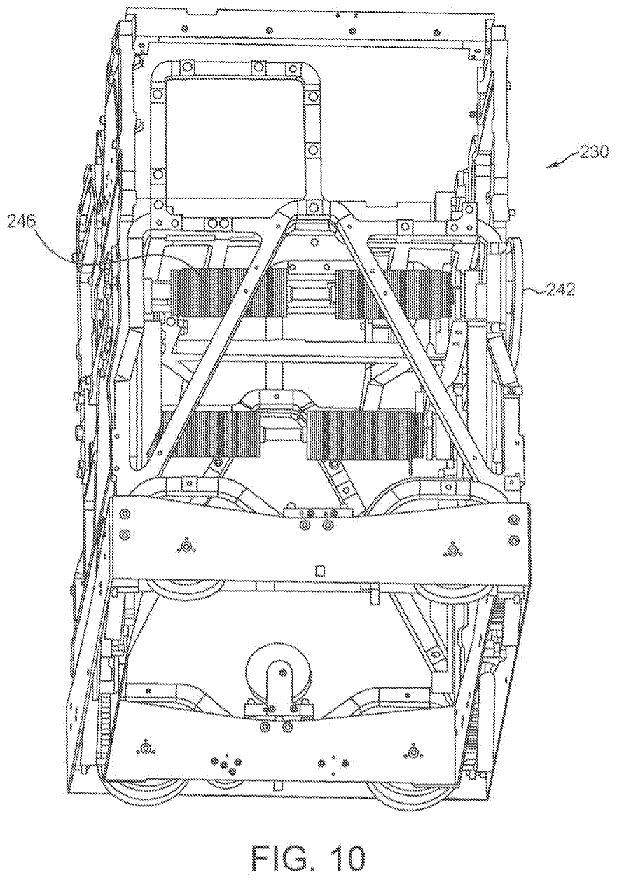

The upper part of the vehicle body may house a majority of the bulky components (not shown) of the load handling device. Optionally, the vehicle body houses the rechargeable power source (not shown). FIGS. 9 to 12 shows a perspective view of the load handling device with the outer casing housing the bulky components removed. Typically, the upper part of the vehicle houses the lifting mechanism or container lifting assembly 242 together with an on-board rechargeable power source (not shown) for providing the power to the drive assembly of the lifting mechanism 242. The rechargeable power source can be any appropriate battery, such as, but not limited to, lithium batteries or even a capacitor. For the purpose of explanation of the present invention, the rechargeable power source is a battery. It is perfectly feasible in the present invention that any of the bulky components such as the rechargeable power source are located anywhere in the body of the vehicle, e.g. in the lower part of the vehicle to lower the centre of gravity of the load handling device 230 and thereby improve the stability of the load handling device. To provide a container receiving space within the body of the load handling device, preferably the rechargeable energy source is integrated into one of the side walls of the body of the vehicle. Further detail of the main components of the load handling device according to the present invention is described in International patent application WO 2015/140216 (Ocado Innovation Limited), the contents of which are incorporated herein by reference.

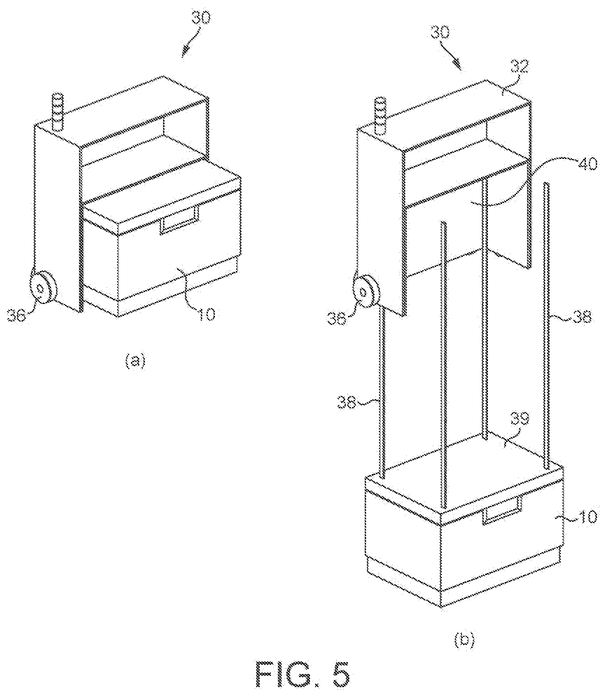

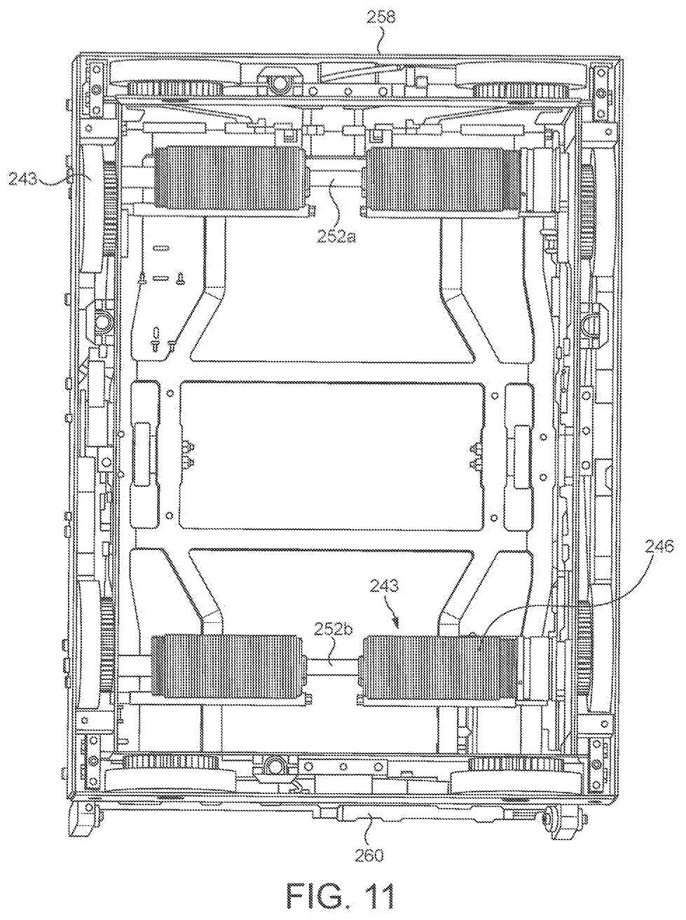

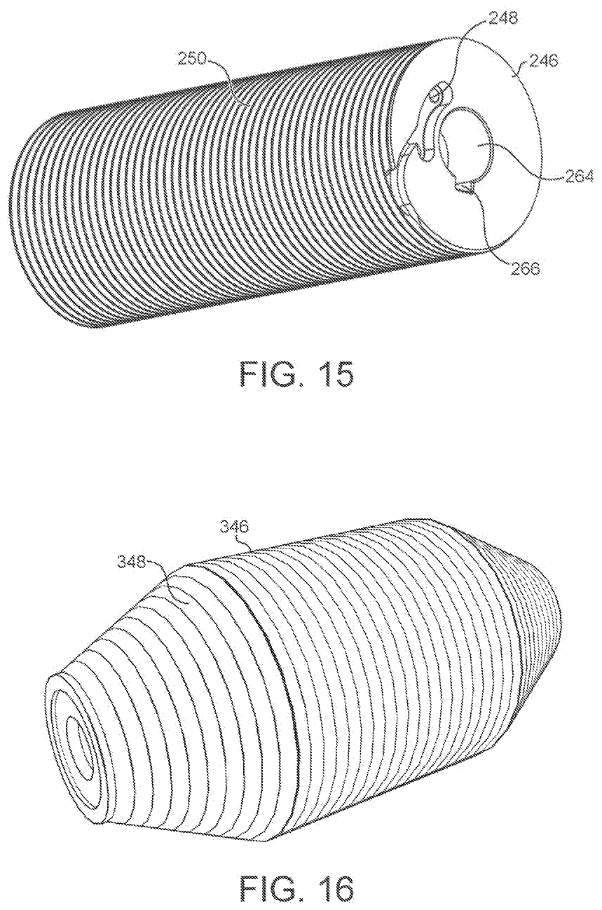

The present invention has mitigated the above problem of the use of a lifting tape to anchor to the grabber device described above with reference to FIG. 6 by providing a lifting mechanism or container lifting assembly 242 comprising a plurality of winch assemblies 243 as shown in FIG. 11, whereby each winch assembly 243 of the plurality of winch assemblies comprises an elongated drum 246 rotatable about its central axis of rotation (see FIG. 11). For the purpose of the particular example of the present invention, the term “elongate” is construed to mean that the longitudinal length of the drum is greater than the cross-sectional diameter of the drum. As with the prior art solutions, the plurality of winch assemblies comprises four winch assemblies, each winch assembly of the four winch assemblies comprising a lifting tether wound on a separate drum 246 and extending between the drive assembly 244 and the grabber device 239, e.g. at the corners of the grabber frame. As discussed above with reference to FIG. 5, the grabber device is configured to releasably engage with the storage container stored in a storage system. In contrast to the prior art lifting mechanism, the winch assembly of the present invention comprises an elongated drum 246. An individual elongated drum 246 as shown in FIG. 15 is configured such that the lifting tether extending between the drive assembly and the grabber device coils around the outer surface of the elongated drum 246 so that multiple axially displaced turns of the lifting tether are wound on the drum. The ability of the lifting tether to coil around the drum as opposed to being wrapped upon each other as in prior art solutions increases the flexibility of different types and shapes of lifting tethers being used to suspend the grabber device. The lifting tether is not limited to a tape or band and other shaped lifting tethers which provide increased flexibility can be used in the present invention as there is no need to control the travelling length of the lifting tether by overlaying the lifting tether in multiple layers as found in prior art solutions. For example, the lifting tether can be in the form of a rope or string or wire or cable and can comprise polymeric materials to provide improved flexibility and yet be able to have sufficiently tensile strength to carry the load of the storage container. One example, of a composition of the lifting tether that offers increased tensile strength and yet is flexible is a polymeric material comprising ultra-high molecular weight polyethylene (UHMwPE) and commercially traded under the name Dyneema®. Dyneema® fiber is 15× stronger than steel at the same weight, with a tensile strength up to 43 cN/dtex. As well as its extraordinary strength, Dyneema® excels in cut and abrasion resistance and has a high resistance to chemicals and UV. Dyneema® fiber is also light in the sense that it floats on water and furthermore has a very high modulus (resistance against deformation).

One end of the lifting tether is anchored to one end of the drum 246 and the lifting tether is wound back and forth between the opposing ends of the drum when lifting and lowering the grabber device. In the particular embodiment shown in FIG. 15, one end of the lifting tether is secured to a hole or recess 248 formed at one end of the drum body 246 and can be secured to the body of the drum by means of a screw (not shown). The receiving hole 248 is located adjacent to one end of the drum 246 as shown in FIG. 15. Other means to anchor the end of the lifting tether to the body of the drum is applicable in the present invention, e.g. use of an adhesive or other fixing methods commonly known in the art to fix the end of the lifting tether to the body of the drum. As the drum is rotated in one direction, the lifting tether is wound in contiguous or helical turns along the length of the drum. As the drum is rotated in one direction, the lifting tether “walks” from one end of the drum to the other end to wrap the drum outer surface with a layer of the lifting tether. Upon reaching one end of the drum, the direction of the wrap can be reversed and another layer of the lifting tether can be wound over the first layer. However, it is preferential that the winch assembly is adapted such that the drum only accommodates a single layer of the lifting tether across the length of the drum. The use of a single layer of the lifting tether helps to reduce wear on the lifting tether. The use of only a single layer of lifting tether may require a larger drum, length and/or diameter, to accommodate a sufficient length of the lifting tether. The amount of helical turns of the lifting tether around the drum is dependent on a number of factors including but is not limited to:
i) the cross-sectional diameter of the lifting tether,
ii) the cross-sectional diameter of the drum;
iii) the length of the drum;
iv) the number of helical turns of the lifting tether around the drum.

For example, for a relatively small cross-sectional diameter of the lifting tether (e.g. less than 1 mm), a greater number of helical turns can be coiled around the outer surface of the drum and thus, a longer length of the lifting tether that can be accommodated on the drum. As there are four winch assemblies, a balance is taken between the availability of space in the upper portion of the vehicle body to accommodate the four winch assemblies and the size of the drum of each of the winch assemblies. With the use of strong materials for the lifting tether such as Dyneema® discussed above, a much thinner lifting tether can be used without comprising the strength of the lifting tether.

To seat the lifting tether as it is coiled around the drum 246, the outer surface of the drum can comprise a helical seat 250 (see FIG. 15). The cross sectional shaped profile of the helical seat 250 has a radius that corresponds to the radius of the cross section of the lifting tether which must be wound on or unwound from the drum outer surface. In the particular embodiment of the present invention, the helical seat comprises helical grooves 250 around the outer surface of the drum 246. The grooves can be machined into the drum or formed during fabrication of the drum, e.g. 3D printing or casting. The drum 246 can be formed as a single body or formed from separate parts. For example, the outer surface of the drum 246 comprising the helical seat can be formed as a removable shell or sleeve that can be slid onto an inner drum or wheel of a smaller diameter to form the drum of the present invention. The removable shell permits the outer surface of the drum comprising the helical grooves to be replaced or re-machined when the depth of the helical grooves falls below a predetermined amount due to wear as a result of the lifting tether rubbing against the outer surface of the drum. The ‘pitch’ of the helical grooves are such to accommodate multiple helical turns of the lifting tether around the outer surface of the drum. Thus, a high pitch represents a greater number of helical grooves on the outer surface of the drum and a low pitch represents a smaller number of helical grooves on the outer surface of the drum. The drum can be composed of metallic material or a composite material comprising a polymeric material. To provide increased wear resistance the outer surface of the drum comprising the helical grooves can hardened, e.g. hardened steel. Other more expensive materials with increased hardness and thus, wear resistance, such as titanium, nickel or an alloy thereof can be used. Alternatively, the outer surface of the drum can comprise a ceramic material due to its increased hardness and wear resistance in comparison to metallic or polymeric material. Suitable ceramic materials used to fabricate the drum, particularly the outer surface of the drum, include but are not limited to silicon carbide, tungsten carbide, boron carbide, alumina etc. The provision of a removable shell comprising the helical grooves provides an advantage that the outer surface can be formed separately and comprise more expensive materials or other exotic materials such as ceramic.

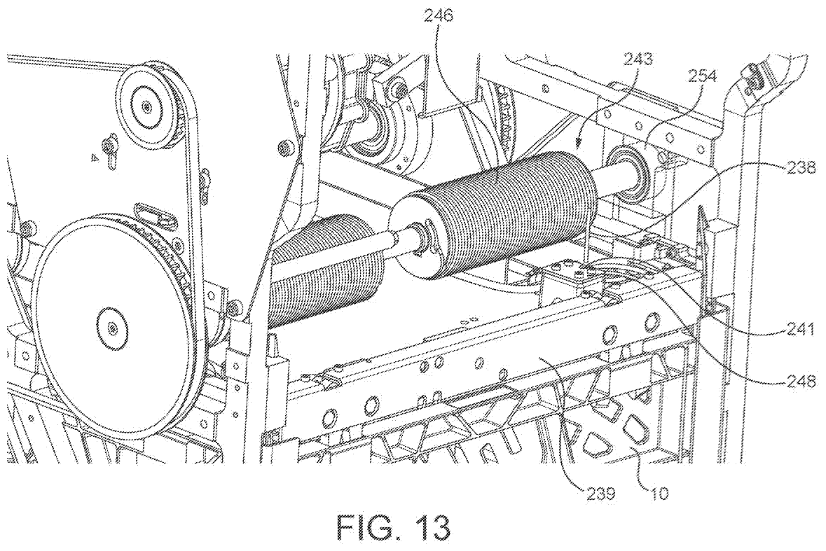

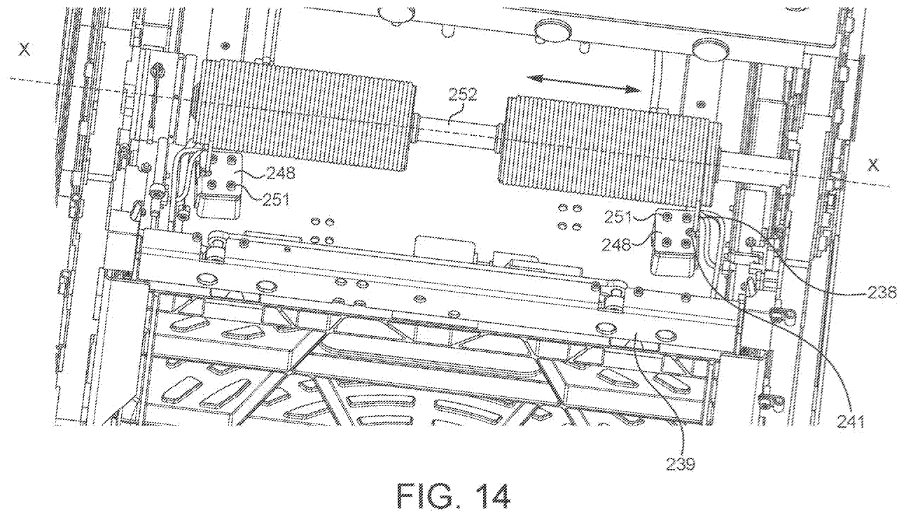

In the particular embodiment of the present invention, each winch assembly 243 of the plurality of winch assemblies comprises a guide member 248 for guiding the lifting tether 238 around the outer surface of their respective drum 246 so as to form adjacent, even helical turns of the lifting tether around the outer surface of the drum (see FIGS. 13 and 14). The guide member is configured so that guide member translates along a direction parallel to the rotational axis of the drum, X-X (see FIG. 14). The guide member 248 ensures that the lifting tether 238 correctly follows the course of the helical seat provided on the drum 246, thereby obtaining efficient and even winding of the lifting tether on the outer surface of the drum. There are two ways in which the guide member can translate the lifting tether across the drum. In a first embodiment of the present invention as shown in FIG. 13, the guide member 248 is fixed and the drum 246 is configured to move relative to the guide member 248 in a direction parallel to the rotational axis of the drum. As shown in FIGS. 13 and 14, the guide member comprises an inlet passage or aperture 241 for feeding or attaching the lifting tether to the grabber device 239 below. The inlet passage extends through a longitudinal length of the guide member. The inlet passage is orientated vertically within the guide member such that the lifting tether passes vertically through the guide member. FIG. 13 shows an entrance to the inlet passage 241, and FIG. 14 shows an exit from the inlet passage 241. The lifting tether 238 is guided by the guide member 248 through the inlet passage to the grabber device 239, where it is anchored to one corner of the grabber device, e.g. to an anchor point 251 on the grabber device. The anchor point 251 can be any fixing means to anchor the end of the lifting tether to the grabber device, e.g. hook, screw etc. In the particular embodiment of the present invention shown in FIGS. 13 and 14, the guide member 248 is formed as an upwardly standing block and fixed to the grabber device 239. Alternatively, there may be other configurations of the guide member, for example, the guide member may be an extendable tube which is fixed to the grabber device. Separate lifting tethers are anchored to the corners of the grabber device such that a lifting tether anchored to each corner of the grabber device is guided by a separate guide member from a respective drum of the present invention. The anchor point 251 is shown in FIG. 14 as separate fixing screws.

The drum 246 is mounted for rotational movement about a horizontal rotational axis on a drive shaft 252 (see FIG. 14). Further detail of the drive mechanism or drive assembly for driving rotation of the drive shaft 252 is discussed below. For avoidance of doubt, the term “drive shaft” and “lifting shaft” are used interchangeably in the patent specification to mean the same feature. Not only does the drive shaft 252 allow rotational movement of the drum about its central axis of rotation X-X but the drum can also move along the drive shaft in a direction parallel to its rotational axis. This is shown by the left and right arrows in FIG. 14. For example, the drum can be mounted on bearings to allow the drum to slide relative to the drive shaft 252 in a direction parallel to its rotational axis but is constrained to rotate when the drive shaft is rotated. Thus, with rotation of the drum, the drum is configured to slide in an axial direction parallel to the rotational axis of the drive shaft X-X as the lifting tether 238 is guided on or off the drum 246 depending on the direction of rotation of the drum. Alternatively, the drum 246 can be fixed to the drive shaft 252 and the drive shaft itself 252 can be configured to translate in an axial direction relative to the guide member 238 to wind or unwind the lifting tether on or off the outer surface of the drum or a combination of both configurations. For example, at least a portion of the outer surface of the drive shaft can threadingly engage with corresponding threads of a mounting 254 (see FIG. 13) of the drive shaft 252 to the vehicle body or chassis such that rotation of the drive shaft 252 can cause the entire drive shaft 252 to translate in an axial direction parallel to its rotational axis.

Alternatively or in combination to moving the drum relative to a fixed guide member, the guide member itself can be configured to move relative to the drum fixed to the drive shaft. For example, the guide member can be configured to threadingly engage with the helical seat of the drum such that rotation of the drum causes the guide member to translate across the outer surface of the drum. The guide member can comprise an inlet passage to thread the lifting tether through the guide member and onto the outer surface of the drum where it is seated in the correct helical groove. As described previously, the inlet passage may extend through a longitudinal length of the guide member. The inlet passage may be orientated vertically within the guide member such that the lifting tether passes vertically through the guide member. In the particular embodiment of the present invention, the drum is configured to translate in an axial direction relative to the guide member as the lifting tether 238 is wound on or off the drum so that the lifting tether coils around the drum in multiple helical turns. In all of the options discussed above, the cooperation between the guide member and the drum is such that rotation of the drum about its central axis of rotation X-X guarantees that the helical turns of the lifting tether are laid correctly in the helical seat giving rise to substantially even winding of the lifting tether around the outer surface of the drum.

The drive assembly 244 for driving the rotation of the drums 246 provides synchronized rotational movement of the drums of the plurality of winch assemblies 243 about their respective rotational axis. In the particular embodiment of the present invention, the drive assembly 244 comprises at least one drive shaft 252 connected to a drive motor 255 and drive pulleys (see FIGS. 9 and 12) via belts and/or chains 256. The at least one drive shaft 252 is mounted for rotational movement about a horizontal rotational axis X-X (see FIG. 14).

In the particular embodiment shown in FIG. 11, the plurality of winch assemblies comprises a first set of drums mounted on a first drive shaft 252a and a second set of drums mounted on a second drive shaft 252b. The first set of drums comprise two drums arranged at the front 258 of the load handling device and the second set of drums comprise two drums arranged at the rear of the load handling device 260. The first set of drums is mounted on a common drive shaft (first drive shaft 252a) and separately arranged to accommodate the lifting tethers anchored to the front two corners of the grabber device (not shown). Equally, the second set of drums is mounted on a common drive shaft (second drive shaft 252b) and separately arranged to accommodate the lifting tethers anchored to the rear two corners of the grabber device (not shown). The first and second drive shafts 252a, 252b are driven to provide synchronized rotational movement of the first and second set of drums by being connected to at least one drive motor 255 via belts or chains 256. In the particular embodiment shown in FIGS. 9 and 12, a single drive motor 255 is connected to the first 252a and second drive shafts 252b via one or more drive pulleys to provide synchronized rotational movement to the first and second sets of drums. A first drive pulley is mounted on the first drive shaft 252a and a second drive pulley is mounted on the second drive shaft 252b. The single motor 255 is connected to the first and second drive shafts via a single belt 256 around the respective first and second drive pulleys 262 of the first and second drive shafts. The single motor is configured to drive a motor drive shaft to which is mounted a motor drive pulley. The single motor is connected to the first and second drive pulleys via the single belt 256 around the respective motor drive pulley and the first and second drive pulleys 262 such that rotation of the motor drive shaft by the single motor drives rotation of the first and second sets of drums.

Each of the drums of the plurality of winch assemblies comprises a central core or hole 264 extending along the central rotational axis of the drum 246 (see FIG. 15), i.e. the drum is formed as a hollow cylinder. The central core 264 is shaped to receive the respective drive shaft and is prevented from freely rotating about the drive shaft by a stop or groove 266 such that the drum rotates when the drive shaft rotates. In the particular embodiment shown in FIG. 15, the central core 264 of the drum comprises a groove 266 that is shaped to receive a correspondingly shaped ridge on the drive shaft which prevents the drum freely rotating about the drive shaft but enables the drum to rotate when the drive shaft rotates. Other means to mount the drum onto the drive shaft to cause the drum to rotate when the drive shaft rotates include but are not limited to various splines comprising teeth on the drive shaft that mesh with correspondingly shaped teeth formed on the inner surface of the central core of the drum. Whilst the groove or spline on the drive shaft prevents the drum from freely rotating about the drive shaft, the drum can be mounted on the drum shaft so as to enable the drum to move in an axial direction along the longitudinal length of the drive shaft. As discussed above, this permits the lifting tether to coil around the drum forming adjacent helical turns on the drum as the drum translates in an axial direction parallel to the rotational axis of the drum or drive shaft. This ensures that the helical turns of the lifting tether are laid correctly on the outer surface of the drum, i.e. evenly wound on the drum. Whilst the particular embodiment of the present invention shown in FIGS. 9 to 14 describes the drive assembly comprising at least one drive shaft driven by a drive motor to provide synchronized rotational movement of the drums, a plurality of winch assemblies can be driven by separate drive motors as discussed with reference to FIG. 6. The plurality of winch assemblies are driven by separate motors to provide synchronized rotational movement of the drums so as to keep the grabber device substantially horizontal. Other means to provide rotational movement of the drums so as to provide synchronized rotational movement of the drums about their respective rotational axis are applicable in the present invention. The shape of each of the drums 246 of the plurality of winch assemblies 243 are shaped such that the cross-sectional diameter of the drum is uniform or substantially uniform along the longitudinal length of the drum. This allows a fixed predetermined travelling length of the lifting tether to be wound on the outer surface of the drum per rotation of the drum. The travelling length of the lifting tether can approximated to the product of the circumference of the drum given by π (pi) x cross-section diameter of the drum and the number of coils of the lifting tether wound around the drum. Each of the drums of the plurality of winch assemblies are rotated in synchronization such that the number of coils around the outer surface of each of the drums are substantially equal and thereby, the length of each of the lifting tethers extending between the drive assembly and the anchor point on the grabber device are equal or substantially equal. This keeps the grabber device horizontal as it is lifted or lowered into a grid cell and prevents any one of the lifting tethers pulling one of the corners of the grabber device more than the other others. For a given rotational speed of the drum, co, the speed by which the grabber device travels vertically is dependent on the cross-sectional diameter of the drum. Thus, for a given rotational speed of the drum, co, a large cross-sectional diameter of the drum is translated to a relatively bigger vertical speed of the grabber device in comparison to a smaller cross-sectional diameter of the drum.

In another embodiment of the present invention, the cross-sectional diameter of the drum can be varied so as to change the vertical speed of the grabber device for a given rotational speed, co, of the drum. For example, different vertical speeds of the grabber device may be required as it approaches into engagement with a storage container in the storage system and/or when the grabber device approaches the container receiving space of the body of the load handling device. An example of providing a drum 346 with a variable cross-sectional diameter is shown in the schematic drawing in FIG. 16. At least a portion of the drum 346 is tapered 348 such that the lifting tether is wound on or off the drum having a variable cross-sectional diameter. In the particular embodiment shown in FIG. 16, opposing ends 348 of the drum are tapered such that the vertical speed of the grabber device varies as the lifting tether is wound or off the tapered portions of the drum. The opposing ends of the drum correspond to the stages when the grabber device is either approaching into engagement with the storage container or when the gabber device is approaching the container receiving space of the body of the load handling device.

Although the illustrated embodiments described above depict the drum rotating around a horizontal rotational axis, in other embodiments the drum may rotate around a rotational axis offset from the horizontal. For example, the drum may rotate around an axis slightly offset from the horizontal. In such an embodiment, the offset of the drum's central axis may facilitate the lifting tether to neatly spool around the drum.

It should be understood that various changes, substitutions and alternations can be made without departing from the scope of the invention as defined by the claims.

1. A load handling device for lifting and moving containers stacked in a storage system having a grid framework with a plurality of grid members arranged in a grid pattern above the stacks of containers, the load handling device comprising:
i) a vehicle body housing a wheel drive mechanism configured and operatively arranged for moving the load handling device on a grid framework, and a wheel assembly including a first set of wheels for engaging with a first set of grid members to guide movement of the load handling device in a first direction and a second set of wheels for engaging with a second set of grid members to guide movement of the load handling device in a second direction, wherein the second direction is transverse to the first direction; and
ii) a container lifting assembly including:
a) a container gripping assembly configured to, in use, releasably grip a storage container;
b) a plurality of winch assemblies, each of the plurality of winch assemblies including a drum rotatable about its central axis of rotation and a lifting tether having a first end anchored to the container gripping assembly and a second end anchored to the drum; and
c) a drive assembly configured to drive rotation of the drums of the plurality of winch assemblies about their respective central axis of rotation to raise the container gripping assembly into a container receiving space;
wherein each of the respective drums of the plurality of winch assemblies has an outer surface that is configured to accommodate a plurality of axially displaced turns of the lifting tether across the drum such that rotation of the drum will cause the lifting tether to form helical turns of the lifting tether around the outer surface of the drum.

2. The load handling device of claim 1, wherein each of the plurality of winch assemblies comprises:
a guide member configured to translate axially along a direction parallel to the central axis of rotation of its respective drum so as to guide the winding and/or unwinding of the lifting tether around the outer surface of the drum.

3. The load handling device of claim 2, wherein the guide member is moveable relative to the drum in the direction parallel to the central axis of rotation of the drum.

4. The load handling device of claim 2, wherein the drum of a respective winch assembly is moveable relative to the guide member in the direction parallel to its central axis of rotation such that rotation of the drum will cause the guide member to translate along a direction parallel to the central axis of rotation of the drum to guide the winding and/or unwinding of the lifting tether around on the outer surface the drum.

5. The load handling device any claim 1, wherein the drum of a respective winch assembly is configured to accommodate only a single layer of the lifting tether when the container gripping assembly is raised into the container receiving space.

6. The load handling device of claim 1, wherein the second end of the lifting tether is anchored to the drum of a respective winch assembly by being received within a recess formed in the drum.

7. The load handling device of claim 1, wherein the outer surface of the drum of a respective winch assembly comprises:
a helical seat including a helical groove for receiving helical turns of the lifting tether.

8. The load handling device of claim 1, wherein the drive assembly comprises:
at least one drive shaft coupled to the respective drums of the plurality of winch assemblies; and
at least one motor for rotating the at least one drive shaft.

9. The load handling device of claim 8, wherein the drive shaft is coupled to the at least one motor by at least one timing belt and/or pulley system and/or gear mechanism such that rotary motion of the least one motor will be transferred to the least one drive shaft to raise and lower the container gripping assembly.

10. The load handling device of claim 8, wherein the plurality of winch assemblies comprises:
a first and second set of drums, and the at least one drive shaft includes first and second drive shafts, the first set of drums being mounted on a first drive shaft and the second set of drums being mounted on a second drive shaft.

11. The load handling device of claim 10, wherein the at least one motor is a single motor.

12. The load handling device of claim 11, wherein the pulley system comprises:
a first drive pulley mounted to the first drive shaft, and a second drive pulley mounted to the second drive shaft, and wherein the single motor is connected to the first and second drive shafts by a single belt around the first and second drive pulleys such that the single motor will drive rotation of the first and second sets of drums.

13. The load handling device of claim 8, wherein the at least one motor comprises:
a plurality of motors, such that the number of winch assemblies is equal to the number of motors.

14. The load handling device of claim 13, wherein the plurality of motors are configured to be driven in synchronisation such that the drums of the plurality of winch assemblies will be driven to rotate about their respective central axis of rotation in synchronisation.

15. The load handling device of any of the claim 1, wherein the plurality of winch assemblies comprises:
four winches, such that the container gripping assembly is anchored to four lifting tethers.

16. The load handling device of claim 15, wherein the container gripping assembly comprises:
a frame having four corners, and each of the four lifting tethers is anchored to one of the respective corners of the container gripping assembly.

17. The load handling device of claim 1, wherein the lifting tether comprises:
Dyneema®.

18. The load handling device of claim 1, wherein the lifting tether is a rope or a cable or a wire.

19. The load handling device of claim 1, wherein at least a portion of the drum of at least one winch assembly has a cross-sectional diameter that is variable.

20. The load handling device of claim 19, wherein at least a portion of the drum of the at least one winch assembly is tapered.

21. The load handling device of claim 1, wherein the vehicle body houses the container receiving space such that the container lifting assembly is configured to, in use, releasably grip a container and lift the container from a stack into the container-receiving space within the vehicle body.

22. The load handling device of claim 1, wherein the first and second set of wheels comprises:
a wheel positioning mechanism configured to selectively lower or raise the first set of wheels or the second set of wheels relative to the vehicle body and thereby, to selectively engage or disengage the first set of wheels with the first set of grid members or the second set of wheels with the second set of grid members.

23. A load handling device according to claim 1, in combination with a storage and retrieval system comprising:
a first set of tracks and a second set of tracks running transversely to the first set in a substantially horizontal plane to form a grid pattern including a plurality of grid spaces or grid cells;
a plurality of stack of containers located beneath the first set of parallel pathways and second set of parallel pathways, wherein each of the stack of containers occupies a single grid space or grid cell; and
the load handling device, arranged to traverse along the first set and the second set of tracks over the plurality of grid spaces or grid cells such that when positioned above a stack of containers occupying a grid space or grid cell, a container lifting assembly is arranged and configured to lift at least one container from said stack of containers.
